(19) United States
(12) Patent Application Publication
(10) Pub. No.: US 2011/0240827 A1
(43) Pub. Date: Oct. 6, 2011

(54) EXHAUST HANGER BAND ASSEMBLY AND TEXTILE SLEEVE EXPANSION LIMITER THEREFOR AND METHOD OF INCREASING THE TENSILE STRENGTH OF AN EXHAUST HANGER BAND

(76) Inventors: Cassie M. Malloy, Blue Bell, PA (US); John Emerson Burdy, Morgantown, PA (US)

(21) Appl. No.: 12/750,805

(22) Filed: Mar. 31, 2010

(51) Int. Cl. D04B 1/22; F16M 13/00; D04B 35/00

(52) U.S. Cl. 248/636; 66/170; 66/147

(57) ABSTRACT

An exhaust hanger band assembly, sleeve therefore, and method of increasing the elongation strength of an exhaust hanger band is provide. The exhaust hanger band assembly includes an elastomeric body configured to operably couple an exhaust member to a frame member of a vehicle. The elastomeric body has an annular outer surface extending along a body central axis between opposite sides. The assembly further includes a textile sleeve having a tubular wall extending along a sleeve central axis in generally parallel relation to the body central axis and between opposite ends. The tubular wall has at least one section of wale direction knit yarns extending along the sleeve central axis and at least one weft inserted yarn extending substantially transversely to the wale direction knit yarns about a circumference of the tubular wall. The at least one weft inserted yarn is interlinked with the at least one section of wale direction knit yarns.

### BACKGROUND OF THE INVENTION

1. Technical Field

This invention relates generally to exhaust hanger band assemblies having an elastomeric body for dampening shock loads, and more particularly to mechanisms used to limit the elongation of an exhaust hanger band assembly.

2. Related Art

It is known to construct exhaust hanger bands having a main body molded of an elastomeric material to incorporate dampening properties to the hanger band. Exhaust hanger bands typically have a pair of through openings spaced from one another, wherein the through openings commonly extend along parallel axes for receipt of separate, generally parallel extending hanger rods therethrough. One of the hanger rods is typically fixed to a frame member of a vehicle and the other of the hanger rods is typically fixed to an exhaust member. During use, the separate hanger rods impart compression and tensile loads on the hanger band as the vehicle encounters bumps on the road, while the elastomeric properties of the body act to dampen vibration that would otherwise result. Unfortunately, the elastomeric properties of the hanger band break down over time, thereby leading to fatigue of the band, which ultimately ends up in the band elongating under tension to a point of fracture. Some of the factors that affect the rate of fatigue failure of the elastomeric band include the magnitude of tensile forces imparted on the band, the duration and frequency of tensile forces imparted on the band, the bumpiness of the terrain being traversed by the vehicle, and the degree of heat exposure from the exhaust system the band see in use.

A hanger band incorporated with textile sleeve manufactured in accordance with the present invention overcomes or greatly minimizes the limitations of the prior art, such as those described above, for example.

### SUMMARY OF THE INVENTION

An exhaust hanger band assembly includes an elastomeric body configured to operably couple an exhaust member to a frame member of a vehicle. The elastomeric body has an annular outer surface extending along a body central axis between opposite sides. The assembly further includes a textile sleeve having a tubular wall extending along a sleeve central axis in generally parallel relation to the body central axis and between opposite ends. The tubular wall has at least one section of wale direction knit yarns extending along the sleeve central axis and at least one weft inserted yarn extending substantially transversely to the warp knit yarns about a circumference of the tubular wall. The at least one weft inserted yarn is interlinked with the at least one section of wale direction knit yarns.

In accordance with another aspect of the invention, a textile sleeve configured to be disposed in a close fit about an elastomeric exhaust hanger band is provided. The textile sleeve has a tubular wall extending along a central axis between opposite ends. The tubular wall has at least one section of wale direction knit yarns extending along the central axis and at least one weft inserted yarn extending substantially transversely to the wale direction knit yarns about a circumference of the tubular wall. The at least one weft inserted yarn is interlinked with the at least one section of wale direction knit yarns.

In accordance with another aspect of the invention, a method of increasing the tensile strength of an elastomeric exhaust hanger band is provided. The method includes providing an elastomeric exhaust hanger band having an annular outer surface and disposing a tubular textile sleeve in a close fit about the annular outer surface.

A textile sleeve manufactured in accordance with the present invention provides a hanger band with an increased capacity to withstand tensile forces, decreases the amount of elongation of the hanger band for a given tensile force applied thereto, increases the ability of the hanger band to withstand radiant heat, extends the useful life of the hanger band, is adapted to be retrofitted over existing hanger bands to easily increase the tensile strength of the existing hanger band, is economical in manufacture and in use.

### BRIEF DESCRIPTION OF THE DRAWINGS

These and other objects, features and advantages will become readily apparent to those skilled in the art in view of the following detailed description of the presently preferred embodiments and best mode, appended claims, and accompanying drawings, in which:

FIG. 1 is a perspective view of an exhaust hanger band assembly including a textile sleeve constructed in accordance with one embodiment of the invention;

FIG. 1A is a view similar to FIG. 1 of an exhaust hanger band assembly including a textile sleeve molded therein in accordance with one embodiment of the invention;

FIG. 2 is an end view of the textile sleeve of FIG. 1;

FIG. 3 is partial schematic view of an inner surface of the textile sleeve showing a knit pattern in accordance with one embodiment used to construct the textile sleeve;

FIG. 4 is schematic elevation view showing an outer surface of the textile sleeve of FIG. 1;

FIG. 5 is partial schematic view of an outer surface of the textile sleeve showing a knit pattern used to construct the textile sleeve;

FIG. 6 is a schematic cross-sectional view of a wall of the textile sleeve taken along a longitudinal axis of the sleeve;

FIG. 7 is a schematic perspective view of a textile sleeve constructed in accordance with another embodiment of the invention;

FIG. 8 is a schematic perspective view of a textile sleeve constructed in accordance with yet another embodiment of the invention; and

FIG. 9 is a graph showing a comparison of the tensile elongation of an exhaust hanger band in accordance with the prior art and an exhaust hanger band incorporated with a textile sleeve in accordance with the invention under a given tensile load.

### DETAILED DESCRIPTION OF PREFERRED EMBODIMENTS

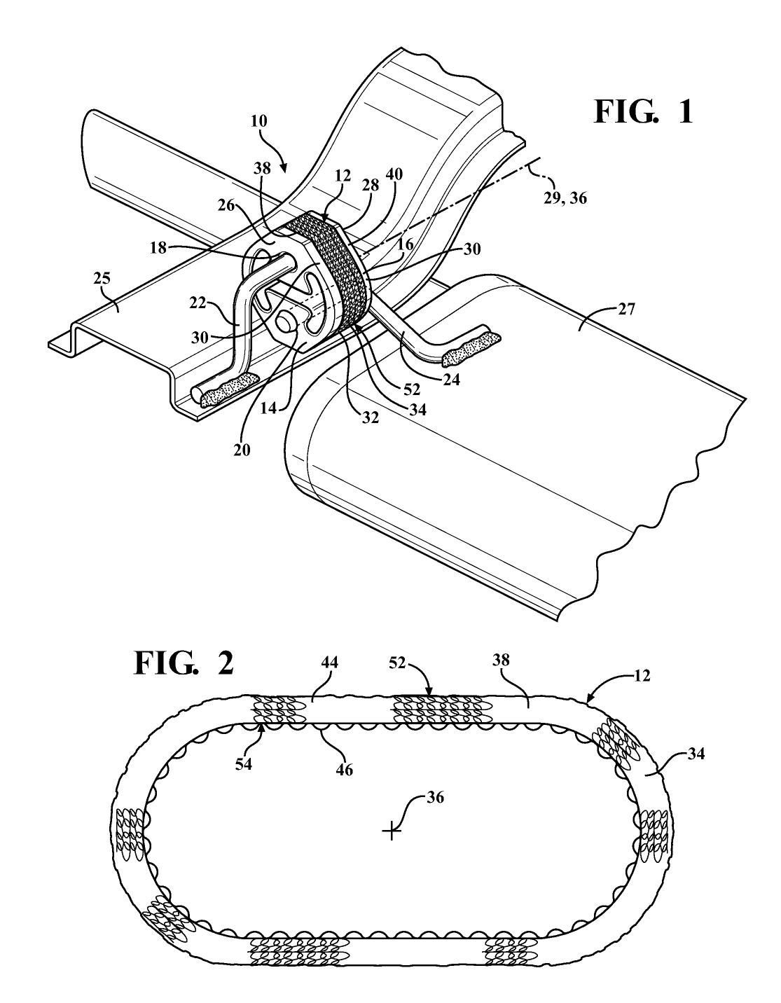

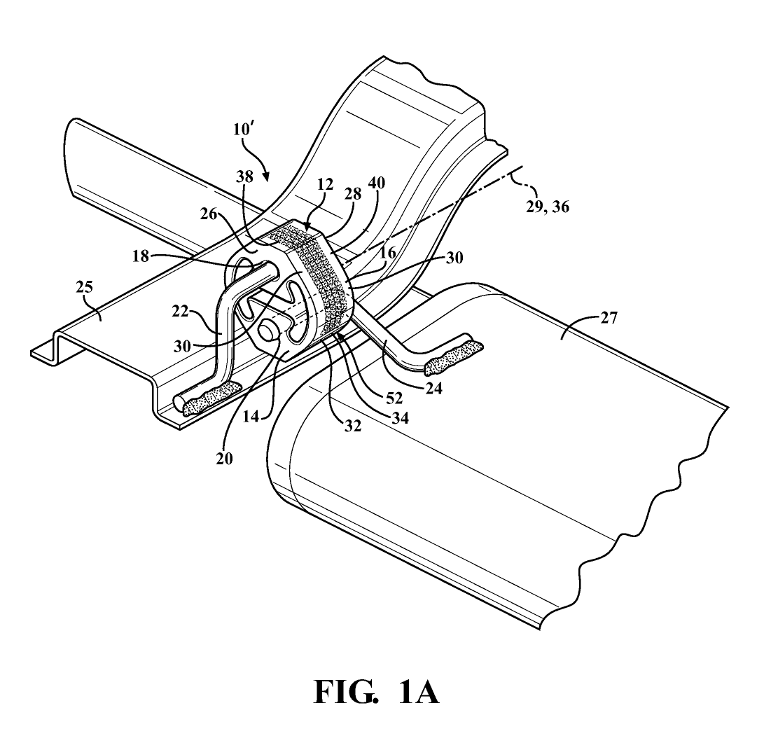

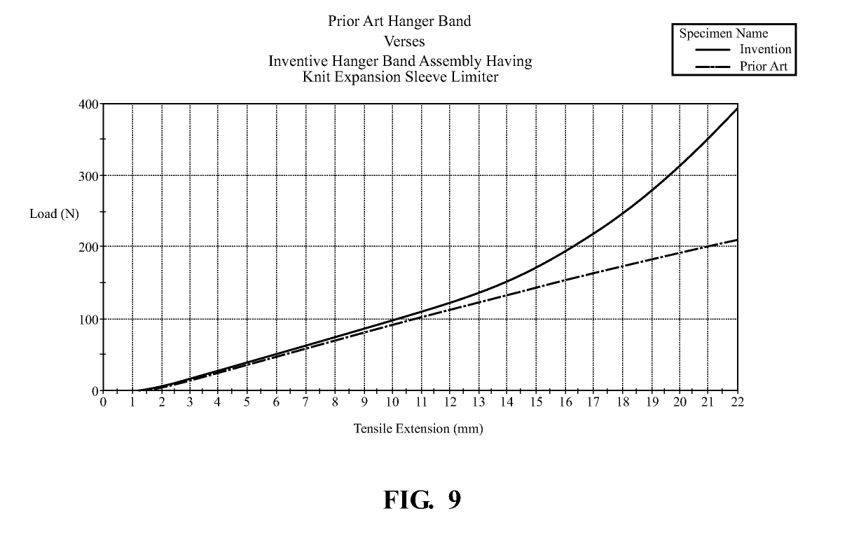

Referring in more detail to the drawings, FIG. 1 shows an exhaust hanger band assembly 10 including an expansion limiter textile sleeve, referred to hereafter simply as sleeve 12, constructed according with one aspect of the invention and a hanger band having an elastomeric body 14. In the embodiment shown in FIG. 1, the body 14 can be provided in accordance with known hanger band configurations, having a variety of shapes and sizes, while the sleeve 12 is constructed to be assembled over an annular outer surface 16 of the hanger band body 14, either as a manufactured assembly, or after market, wherein the sleeve 12 is disposed over an already existing hanger body 14 to provided added strength to the body 14. Upon disposing the sleeve 12 over the body 14, the body 14 retains its useful elasticity, thereby remaining functional to absorb and dampen vibration in use, however, the sleeve 12 acts, among other things, to limit the distance of tensile elongation of the body 14, as is shown in a graph of FIG. 9. As such, the body 14 is able to withstand high tensile loads without being stretched to a point of fatigue, thereby enhancing the useful life of the hanger band body 14.

The hanger body 14 has a pair of through openings 18, 20 spaced from one another, wherein the through openings 18, 20 extend along parallel axes for receipt of separate, generally parallel extending hanger rods 22, 24 therethrough. One of the hanger rods 22 is configured to be fixed to a frame member of a vehicle (not shown) and the other of the hanger rods 24 is fixed to an exhaust member (not shown). Accordingly, the hanger body 14 is configured to operably couple the exhaust member to the vehicle. The outer surface 16 of the hanger body 14 has a width extending along a central axis 29 between opposite sides 26, 28, and preferably includes raised, circumferentially extending edge 30 adjacent each side 26, 28. As such, the outer surface 16 has a slightly reduced annular diameter portion 32 extending between the opposite radially outwardly flared edges 30.

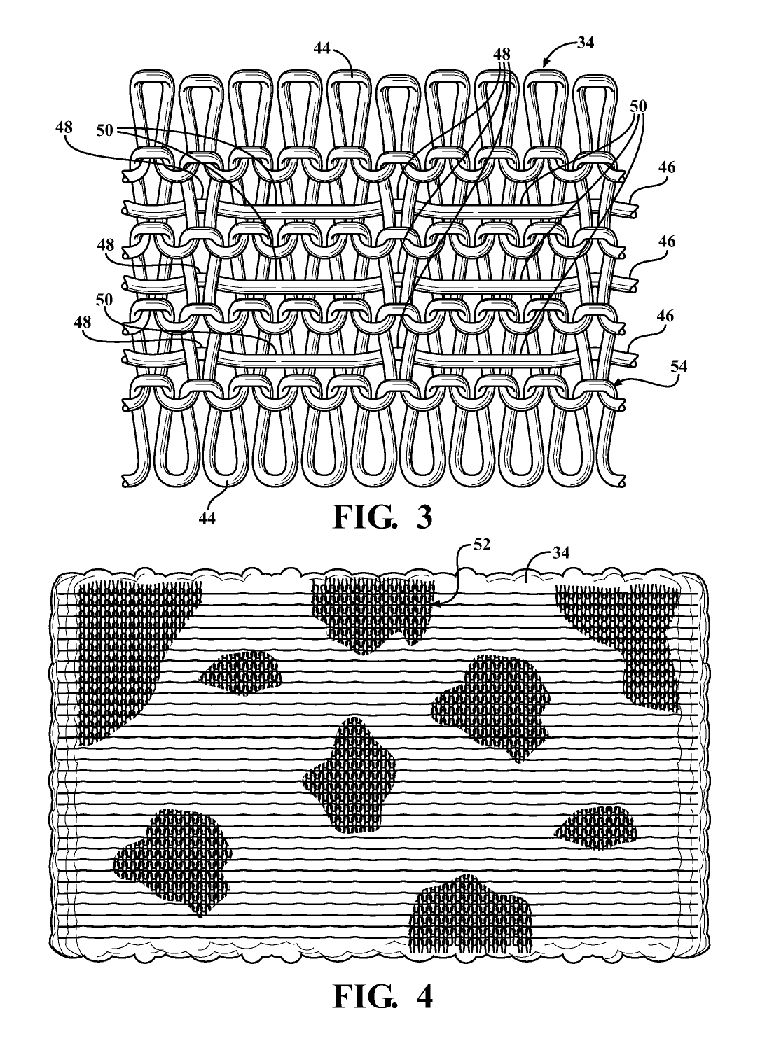

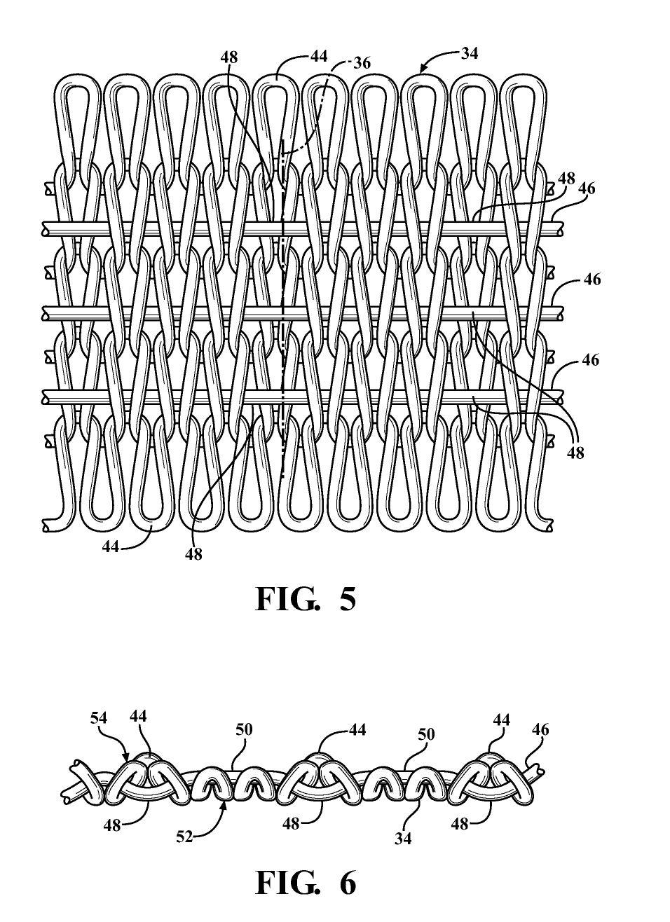

As best shown in FIG. 1, the sleeve 12 has a tubular wall 34 extending along a sleeve central axis 36 between opposite open ends 38, 40. As best shown in FIGS. 3 and 5, the wall 34 has at least one section 42 of wale direction knit yarns 44 extending along the central axis 36 and at least one weft laid-in yarn, also referred to as weft inserted yarn 46, extending substantially transversely to the central axis 36 and the wale direction knit yarns 44 about a circumference of the tubular wall 34. The weft inserted yarn 46 is interlinked with the wale direction knit yarns 44 via tuck stitches 48, as best seen in FIG. 6, and have floats 50 extending outwardly in a straight orientation over a plurality of the wale direction knit yarns 44. As such, the weft inserted yarn 46 extends about the circumference of the tubular wall 34 using a minimal amount of yarn, as the yarn does not have “knit” loops, but rather extends along a substantially straight path, thereby having minimal crimp, and thus, having minimal elongation upon encountering radially acting forces. The wale direction and weft inserted yarns 44, 46 can be provided of a variety of materials, and specifically for weft inserted yarns 46 it is preferably provided as a high tensile yarn, such as para-aramid (Kevlar, Twaron), liquid crystal polymers (Vectran), High Tenacity polymers (PET, Nylon) for example, and further, having a relatively large denier, such as about 1000, for example. As such, the wale direction and weft inserted yarns 44, 46 are provided having a very high breaking strength and very low elongation. In addition, the yarns 44, 46 are also provided having excellent resistance to high temperatures, such as those encountered immediately adjacent an exhaust system of a vehicle.

In the embodiment illustrated in FIGS. 1-6, the wale direction knit yarns 44 extend continuously about the circumference of the tubular wall 34 and continuously between the opposite ends 38, 40. Accordingly, the wale direction knit yarns 44 form a continuous outer surface 52 and inner surface 54 of the tubular wall 34. The weft knit yarn 46, as discussed above, is inserted with the warp knit yarns 44 along a weft direction, and in the embodiment shown, are inserted having the floats 50 extending along the inner surface 54 (FIGS. 3 and 5), though they could float radially outwardly of the wale direction yarns 44, if desired. As such, from viewing the outer surface 52, the weft yarn 46 is barely visible. The wale direction knit yarns 44 can be knit using any variety of knit stitches, such as, by way of example and without limitation, a jersey knit stitch, an interlock knit stitch, a rib knit stitch. In addition, the wale direction knit yarns 44 are finish knit at the ends 38, 40, without any of the weft inserted yarn 46 present at the ends 38, 40.

As shown in FIG. 1A, an exhaust hanger band assembly 10′ has a sleeve 12 constructed similarly as described above, however, rather than the sleeve 12 being disposed over an outer surface of the elastomeric hanger body 14, hanger body 14 is molded to the sleeve 10′. In the embodiment shown, the elastomeric hanger body 14 is over-molded about the sleeve 12 such that the sleeve 12 insert molded within the elastomeric material of the hanger body 14. Accordingly, the sleeve 12 and hanger body 14 are manufactured as an integral, inseparable one-piece assembly, wherein the sleeve 12 is not visible, but rather encapsulated by the material of the body 14. Of course, the sleeve 12 could remain as an exterior member if the elastomeric material is molded radially inwardly of the sleeve 12, such that the sleeve 12 is bonded to the molded material of the body 14 in the molding process to the outer surface of the body 14. Otherwise, the sleeve 12 functions as described above to extend the useful life of the assembly 10′ by inhibiting the body 14 from becoming stretched elastically beyond a predetermined circumferential limit of the sleeve 12, and further, acts to prevent premature fatigue of the body 14.

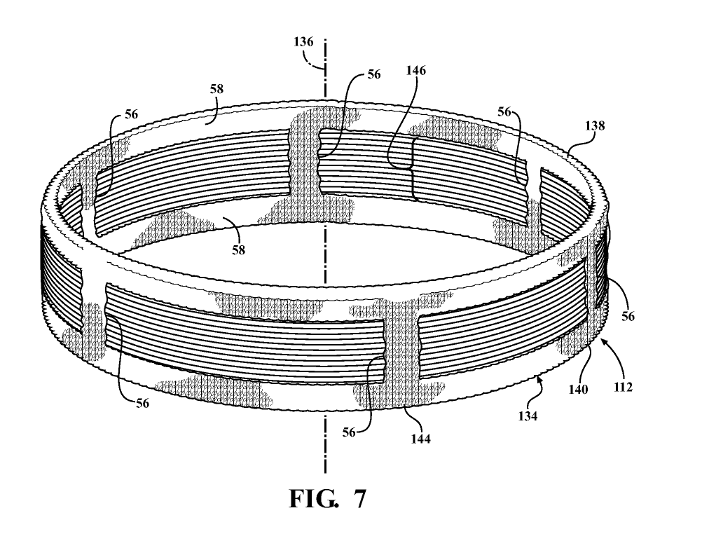

In FIG. 7, a sleeve 112 is shown in accordance with another embodiment of the invention, wherein the same reference numerals used above offset by a factor of 100 are used to identify similar features as discussed above with regard to the sleeve 12.

The sleeve 112 has a tubular wall 134, but, rather than the wall 134 having a circumferentially continuous interlaced network of knit wale direction yarns extending between opposite ends 138, 140, the sleeve 112 has wale direction knit yarns 144 configured in circumferentially spaced wale direction knit sections 56 about the tubular wall 134, wherein the sections 56 extend generally parallel to a longitudinal central axis 136 of the sleeve 112. In addition, the circumferentially spaced wale direction knit sections 56 are interconnected by annular wale direction knit sections 58 extending about the circumference of the tubular wall 134. The annular wale direction knit sections 58 are shown as extending about and forming the opposite ends 138, 140 of the tubular wall 134, by way of example.

As with the previously discussed sleeve 12, the sleeve 112 has at least one weft inserted yarn 146 interlaced with at least some of the wale direction knit yarns 144, such that the wale direction knit yarns 144 hold the weft inserted yarns 146 in position. In the embodiment shown, the weft inserted yarn 146 are interlaced with the wale direction knit sections 56 that extend along the central axis 136, but not with the annular wale direction knit sections 158 that form the ends 138, 140. As discussed above, the weft inserted yarn 146 provides the sleeve 112 with a predetermined, fixed radial elongation, which prevents the elastomeric hanger band body 14 from becoming elongated beyond the elongation limit of the sleeve 112, thus, extending the useful life of the hanger band body 14.

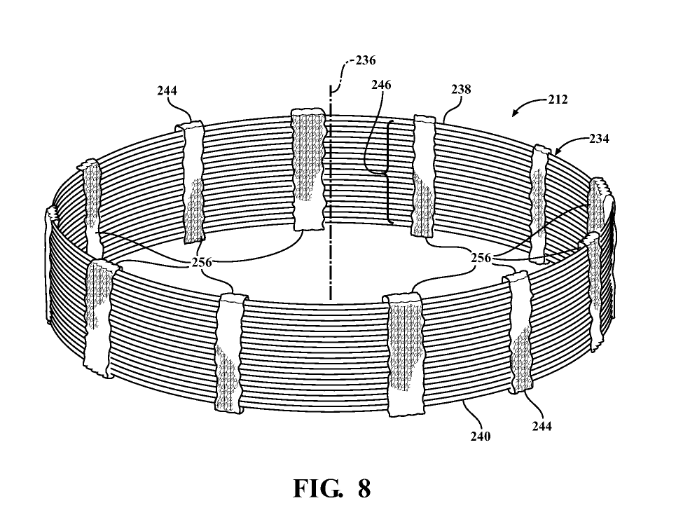

In FIG. 8, a sleeve 212 is shown in accordance with another embodiment of the invention, wherein the same reference numerals used above offset by a factor of 200 are used to identify similar features as discussed above with regard to the sleeve 12.

The sleeve 212 is similar to the sleeve 112, having a tubular wall 234 extending between opposite ends 238, 240, with wale direction knit yarns 244 configured in circumferentially spaced wale direction knit sections 296 about the tubular wall 234, wherein the sections 296 extend generally parallel to a longitudinal central axis 236 of the sleeve 212. However, the circumferentially spaced wale direction knit sections 296 are not interconnected by annular wale direction knit sections, but rather, remain completely separate as discrete sections 296.

As with the previously discussed sleeve 12, the sleeve 212 has at least one weft inserted yarn 246 interlaced with at least some of the wale direction knit yarns 244. The weft inserted yarn 246 are interlaced with the warp knit sections 296 that extend along the central axis 236, and provide the sleeve 212 with a predetermined, fixed radial elongation, which prevents the elastomeric hanger band body 14 from becoming elongated beyond the elongation limit of the sleeve 212, thus, extending the useful life of the hanger band body 14.

It is to be understood that other embodiments of the invention which accomplish the same function are incorporated herein within the scope of this invention. It is also to be understood that hanger band assemblies can be manufactured in a variety of shapes, sizes and diameters, such as by altering the size and shape of the knit sleeve. The invention is defined by the claims that issue from this application and any related applications.

What is claimed is:

1. An exhaust hanger band assembly, comprising:
an elastomeric body configured to operably couple an exhaust member to a frame member of a vehicle, said elastomeric body having an annular outer surface extending along a body central axis between opposite sides; and
a textile sleeve having a tubular wall extending along a sleeve central axis in generally parallel relation to said central axis of the elastomeric body and between opposite ends, said wall having at least one section of wale direction knit yarns extending along said central axis and at least one weft inserted yarn extending substantially transversely to said wale direction knit yarns about a circumference of said tubular wall, said at least one weft inserted yarn being interlinked with said at least one section of wale direction knit yarns.

2. The exhaust hanger band assembly of claim 1 wherein said textile sleeve extends circumferentially about said outer surface of said elastomeric body.

3. The exhaust hanger band assembly of claim 1 wherein said elastomeric body is molded to said textile sleeve

4. The exhaust hanger band assembly of claim 3 wherein said elastomeric body is overmolded about said textile sleeve.

5. The exhaust hanger band assembly of claim 1 wherein said at least one section of wale direction knit yarns extends continuously about said tubular wall.

6. The exhaust hanger band assembly of claim 5 wherein said at least one weft inserted yarn has float portions extending transversely to said wale direction knit yarns.

7. The exhaust hanger band assembly of claim 6 wherein said float portions extend along an inner surface of said tubular wall.

8. The exhaust hanger band assembly of claim 1 wherein said at least one section of warp knit yarns form circumferentially spaced warp knit sections about said tubular wall.

9. The exhaust hanger band assembly of claim 8 wherein said circumferentially spaced wale direction knit sections are interconnected by at least one annular wale direction knit section extending about said circumference of said tubular wall.

10. The exhaust hanger band assembly of claim 9 wherein said at least one annular wale direction knit section forms said opposite ends of said tubular wall.

11. A textile sleeve configured to be disposed in a close fit about an elastomeric exhaust hanger band, comprising:
a tubular wall extending along a central axis between opposite ends, said wall having at least one section of wale direction knit yarns extending along said central axis and at least one weft inserted yarn extending substantially transversely to said wale direction knit yarns about a circumference of said tubular wall, said at least one weft inserted yarn being interlinked with said at least one section of wale direction knit yarns.

12. The textile sleeve of claim 11 wherein said at least one section of wale direction knit yarns extends continuously about said tubular wall.

13. The textile sleeve of claim 12 wherein said at least one weft inserted yarn has float portions extending transversely to said wale direction knit yarns.

14. The textile sleeve of claim 13 wherein said float portions extend along an inner surface of said tubular wall.

15. The textile sleeve of claim 11 wherein said at least one section of wale direction knit yarns form circumferentially spaced wale direction knit sections about said tubular wall.

16. The textile sleeve of claim 15 wherein said circumferentially spaced wale direction knit sections are interconnected by at least one annular wale direction knit section extending about said circumference of said tubular wall.

17. The textile sleeve of claim 16 wherein said at least one annular wale direction knit section forms said opposite ends of said tubular wall.

18. A method of increasing the tensile strength of an elastomeric exhaust hanger band, comprising:
providing an elastomeric exhaust hanger band having an annular outer surface; and
disposing a tubular textile sleeve in a close fit about the annular outer surface.

19. The method of claim 18 further including knitting a wall of the textile sleeve having at least one section of wale direction knit yarns extending between opposite ends along a central axis and having at least one weft inserted yarn extending substantially transversely to the wale direction knit yarns about a circumference of the tubular wall and interlinking the at least one weft inserted yarn with the at least one section of wale direction knit yarns.

20. The method of claim 19 further including knitting the at least one section of wale direction knit yarns continuously about the tubular wall.

21. The method of claim 20 further including providing the at least one weft inserted yarn with float portions extending transversely to the wale direction knit yarns.

22. The method of claim 21 further including extending the float portions along an inner surface of the tubular wall.

23. The method of claim 18 further including knitting the at least one section of wale direction knit yarns in circumferentially spaced wale direction knit sections about the tubular wall.

24. The method of claim 23 further including interconnecting the circumferentially spaced wale direction knit sections with at least one annular wale direction knit section extending about the circumference of the tubular wall.

25. The method of claim 24 further including forming the opposite ends of the tubular wall with said at least one annular wale direction knit section.
